(19) United States
(12) Patent Application Publication
(10) Pub. No.: US 2002/0075296 A1
(43) Pub. Date: Jun. 20, 2002

(54) Internet terminal having operation proxy channel button of web site

(76) Inventors: Takumi Soen, Kochi-Shi (JP); Keiko Soen, Kochi-Shi (JP)

Correspondence Address: SHLESINGER, ARKWRIGHT & GARVEY LLP, 3000 South Eads Street, Arlington, VA, 22202, US

(21) Appl. No.: 09/735,466

(22) Filed: Dec. 14, 2000

(30) Foreign Application Priority Data
Oct. 31, 2000 (JP) 2000-333997

(51) Int. Cl. G06F 13/00

(52) U.S. Cl. 345/733

(57) ABSTRACT

An object of the present invention is to provide an Internet terminal able to retrieve and order goods, or receive various kinds of onerous and gratuitous business services by the proxy operation of an operator in a remote place without personally operating the Internet terminal by a user.

In the basic construction of an Internet terminal having an operation proxy channel button of a Web site, the Internet terminal 14 mounting a Web browser thereto on a user side is connected to a server channel 1 to 5 for operation proxy through the Internet 24, and a single or plural operation proxy channel buttons 23 of the Web site and communication means with an operator 7, 7, of the server channel 1 to 5 for operation proxy are arranged in the Internet terminal 14. Connection with a Web site server channel and other operations are performed by proxy-operating the Web browser of the Internet terminal 14 on the user side by the operator 7, 7, - - - through the Internet 24 on the basis of commands of the user through the communication means.

### BACKGROUND OF THE INVENTION

1. Field of the Invention

The present invention relates to an Internet terminal having an operation proxy channel button of a Web site in which a business service such as a commercial transaction of shopping, etc., various kinds of information provisions and others provided on the Web of the Internet can be easily utilized without personally operating the Internet terminal by a user.

2. Description of the Background Art

In the business service such as Web shopping, various kinds of information provisions and others provided on the Web of the Internet, connection of the Internet is conventionally made by using various kinds of Internet terminals, e.g., a personal computer mounting a Web browser thereto in a user's home, a game machine, an electronic note, a portable phone, an Internet terminal arranged in a convenience store, a dedicated terminal, etc. A user generally personally operates the Web browser, and retrieves and orders goods, and receives provided information. Otherwise, the user generally receives various kinds of provided onerous and gratuitous business services.

However, the user must personally operate the Web browser of the Internet terminal to perform the commercial transaction of shopping, etc. and the various kinds of onerous and gratuitous business services provided on the Web of the above Internet. Therefore, it is often not suitable for all people. Accordingly, a problem exists in that an obstacle is caused in an increase in utilization.

Namely, an operating method of the personal computer often used as the Internet terminal is generally complicated. Accordingly, there are many users unable to operate the personal computer and weak in the operation of the personal computer. It is necessary to sufficiently learn an annexed manual, or purchase a guide sold at a market and study the personal computer for a long time so as to operate this personal computer. Further, no user can use the personal computer unless the user goes to a personal computer school and sufficiently masters the operating method. In particular, the number of users unable to freely use the Internet terminal is increased in an aging society in the future. Accordingly, the difference in information between a person able to use the personal computer and a person unable to use the personal computer is caused. Therefore, it is expected that this difference becomes an obstacle in the formation of a fair society.

### SUMMARY OF THE INVENTION

To solve the above problems, an object of the present invention is to provide an Internet terminal having an operation proxy channel button of a Web site able to retrieve and order goods, or receive various kinds of onerous and gratuitous business services by the proxy operation of an operator in a remote place without personally operating the Internet terminal by a user.

To achieve the above object, the present invention resides in the basic construction of an Internet terminal having an operation proxy channel button of a Web site, characterized in that the Internet terminal mounting a Web browser thereto on a user side is connected to a server channel for operation proxy through the Internet, and a single or plural operation proxy channel buttons of the Web site and communication means with an operator of the server channel for operation proxy are arranged in the Internet terminal, and connection with the Web site server channel and other operations are performed by proxy-operating the Web browser of the Internet terminal on the user side by the operator through the Internet on the basis of commands of the user through the communication means.

The present invention also provides the construction of an Internet terminal having an operation proxy channel button of a Web site, characterized in that the Internet terminal on a user side is connected to a server channel for operation proxy through the Internet, and a single or plural operation proxy channel buttons of the Web site and communication means with an operator of the server channel for operation proxy are arranged in the Internet terminal, and various kinds of connections with the Web site server channel and other operations are performed by proxy-operating a Web browser of the Internet terminal on the user side by the operator through the Internet on the basis of commands of the user through the communication means so that the user receives the provision of a commercial transaction or various kinds of business services on the Web site server.

The Internet terminal is connected to one of the single or plural server channels for operation proxy by selecting one of said single or plural operation proxy channel buttons of the Web site, and contents of one of the Web site server channels corresponding to the pertinent server channel for operation proxy are displayed on a Web browser screen of the Internet terminal. A virtual operator is made as the operator of the server channel for operation proxy by agent software of a computer, and proxy-operates the Web browser of the Internet terminal on the user side on the basis of the commands of the user. Further, the operation proxy channel button of the Web site is used by selecting this button from a hardware button of a dial and others assembled into the Internet terminal, or a software button displayed on a screen able to perform an input operation such as a touch panel, etc., a button assembled into a remote controller able to be connected to the Internet terminal by an infrared or wireless interface, and other remote operation buttons.

Further, means of a chat through the Internet, an Internet telephone, an Internet TV telephone, etc. are used as the communication means of the user and the operator. The operator can perform a proxy-operation required for retrieval, an application, etc. for receiving a provided business by making connection with a Web site server channel for various kinds of business services such as various kinds of support businesses, information providing business, public service business, etc. as the Web site server channel. Further, the records of operations of the Internet terminal performed by the operator on the user side are accumulated to a database by the server channel for operation proxy, and the user can confirm the records, or a provider of the Web site server channel can utilize the records as information. A personal computer mounting the Web browser thereto, a game machine, a portable terminal, a portable phone, a terminal unit arranged within a convenience store, a specialty store or a vehicle for mobile sales, and an electronic device for home able to be connected to the Internet such as a Web TV, etc. are used as the Internet terminal on the user side.

In accordance with such an Internet terminal having the operation proxy channel button of the Web site, when the user performs a commercial transaction and various kinds of business services of the Web site server channel, or the Web site server channel for various kinds of business services such as various kinds of support businesses, information providing business, public service business, etc., the Internet terminal on the user side is started and connected to the Internet, and the Web browser screen is displayed. Thereafter, the user pushes one operation proxy channel button of the Web site as a utilizing object from the single or plural operation proxy channel buttons of the Web site. Thus, the Internet terminal is connected to one of the server channels for operation proxy corresponding to the pertinent channel through the Internet, and a picture image of the operator is displayed in the communication means such as a TV telephone screen, etc. Further, contents of one of the Web site server channels corresponding to the pertinent channel are displayed on the Web browser screen. Simultaneously, the picture image of the user and the Web browser screen on the user side are displayed in a server for operation proxy on an operator side. Thus, it attains a state in which the proxy operation of the Internet terminal on the user side is performed.

Therefore, the user transmits contents of the commercial transaction or various kinds of business services to the operator by a normal conversation. The operator then proxy-operates the Web browser of the user, etc. by using the server for operation proxy, and can perform an operation of the Internet terminal as an object, or can perform the proxy operation until shopping or various kinds of business services on the Web are completed.

### BRIEF DESCRIPTION OF THE DRAWING

FIG. 1 is a systematic view entirely showing one example of an Internet terminal having an operation proxy channel button of a Web site in the present invention.

### DESCRIPTION OF THE PREFERRED EMBODIMENTS

A concrete embodiment mode of an Internet terminal having an operation proxy channel button of a Web site in the present invention will next be explained on the basis of the drawing. The Internet terminal in the present invention includes all of a personal computer mounting a Web browser thereto, a game machine, an electronic note, a portable phone, a terminal unit arranged in a convenience store, a dedicated terminal, an electronic device able to be connected to the Internet such as a Web TV, etc. Transaction on the Web is a concept including all of shopping or the utilization, etc. of a Web site server channel for various kinds of business services on the Web, all transactions utilizing the Web site server channel and an operation of the Web site server channel, and an action required to perform this operation.

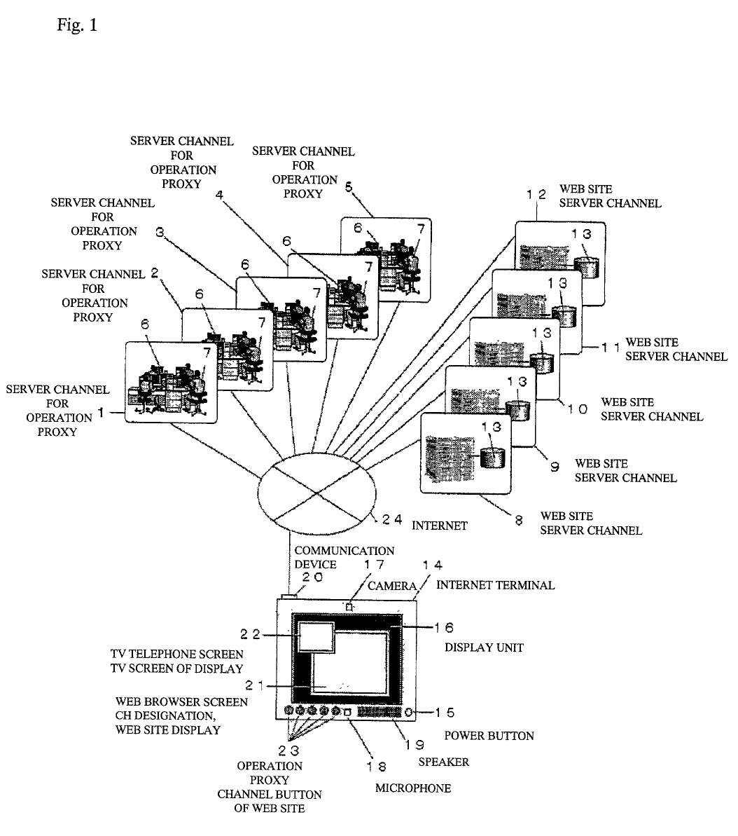

FIG. 1 is a systematic view entirely showing one example of the Internet terminal in this embodiment mode. In FIG. 1, each of reference numerals 1, 2, 3, 4 and 5 designates a server channel for operation proxy. Each of the server channels 1, 2, 3, 4 and 5 for operation proxy has a function for executing the proxy of a transaction on the Web. Servers 6, 6, - - - for operation proxy of the Internet terminal are arranged within the respective server channels 1, 2, 3, 4, and 5 for operation proxy, and operators 7, 7, - - - are permanently stationed.

Virtual operators 7, 7, - - - are made in advance as the operators 7, 7, - - - by agent software of a computer. The virtual operators 7, 7, - - - may also perform a proxy operation of the Web browser of the user on the Web while these virtual operators 7, 7, - - - have a conversation with a user.

Each of reference numerals 8, 9, 10, 11 and 12 designates a Web site server channel. For example, this Web site server channel is a Web site server channel for a virtual shop, or a Web site server channel for various kinds of business services, etc. Necessary information such as goods information, service information, etc. is registered to auxiliary memory devices 13, 13, - - - of a hard disc, etc. within these Web site server channels 8, 9, 10, 11 and 12, and connection with the exterior can be made through the Internet.

On the other hand, reference numeral 14 designates an Internet terminal on a user side. In the illustrated example, a note personal computer mounting the Web browser thereto as the Internet terminal 14 is set to a basic construction. Main constructional elements of this Internet terminal 14 will next be explained. Reference numerals 15, 16 and 17 respectively designate a power button, a display unit such as a liquid crystal display, etc., and a camera with video capture. Reference numerals 18, 19 and 20 respectively designate a microphone for inputting a voice, a speaker and a communication device. Reference numerals 21 and 22 respectively designate a Web browser screen and a TV telephone screen. A means such as a chat, an Internet telephone, an Internet TV telephone, etc. through the Internet can be also used as a communication means of the user and the operator instead of the TV telephone. Further, a communication means of only a voice without any image may be also used. Reference numeral 23 designates an operation proxy channel button of the Web site. Five operation proxy channel buttons \mathring{1} \mathring{2} \mathring{3} \mathring{4} \mathring{5} of the Web site in total selected in accordance with a use object of the user are arranged as the operation proxy channel button 23 of the Web site every Web site.

A button selected from a hardware button of a dial and others assembled into the Internet terminal, or a software button displayed on the screen able to perform an input operation of a touch panel, etc., a button assembled into a remote controller able to be connected to the Internet terminal by an infrared or wireless interface, and other remote operation buttons can be used as this operation proxy channel button 23 of the Web site.

An OS for operating the Web browser screen 21 is mounted to the Internet terminal 14. A modem, a LAN, a wireless communication device, etc. for connection with the Internet are built in the above communication device 20. The Internet terminal 14 itself is a computer device having no keyboard and no mouse. An input device of the keyboard, the mouse, etc. may be also attached to the Internet terminal as an option for a skilled person. Further, another input device of the touch panel, a tablet, etc. can be also used. The display unit 16, the camera 17, the microphone 18, the speaker 19 and the communication device 20 can be set to be of a built-in type shown in the illustrated example, and can be also arranged as parts externally attached.

Reference numeral 24 designates the Internet as a communication network. The Internet terminal 14 on the user side can be connected to the Internet 24 by a telephone line, a dedicated line or wireless communication, and can be connected to one of the above server channels 1, 2, 3, 4, 5 for operation proxy and the Web site server channels 8, 9, 10, 11, 12 through this Internet 24.

Table 1 shows one example of a URL definition information table every channel of the operation proxy button assembled into a memory device or an auxiliary memory device of the Internet terminal 14, or a memory device or an auxiliary memory device of the server 6 for operation proxy in the above server channels 1, 2, 3, 4, 5 for operation proxy. When the user pushes one of the operation proxy channel buttons 23 \mathring{1} to \mathring{5} of the Web site, the information of an operation proxy server address (URL) and a Web site address (URL) shown in the table 1 can be immediately obtained from pertinent information. All operation proxy server addresses (URL) may be set to be the same. In this case, all proxy operations are performed by one server channel for operation proxy instead of the user. In the Web site server channel example of the table 1, channels 1, 2, 3, 4 and 5 are respectively set to an OLINE portal, information retrieval, shopping, a stock trade and sight-seeing information.

TABLE 1

| operation proxy | | |
|---|---|---|
| channel button | operation proxy | Web site address |
| number (CHn) | server address (URL) | (URL) |
| \mathring{1} | CH1.OLINE.NE.JP | WWW.OLINE.NE.JP |
| \mathring{2} | CH2.OLINE.NE.JP | WWW.YAHOO.CO.JP |
| \mathring{3} | CH3.OLINE.NE.JP | WWW.RAKUTEN.NE.JP |
| \mathring{4} | CH4.OLINE.NE.JP | WWW.ETRADE.NE.JP |
| \mathring{5} | CH5.OLINE.NE.JP | WWW.ATTAKA.CO.JP |

(explanation of Web site)
(OLINE portal)
(retrieval)
(shopping)
(stock trade)
(sight-seeing information of Kochi prefecture)

A concrete operation mode of the Internet terminal 14 having an operation proxy channel button of the Web site in such a construction will next be explained. When the user receives business services such as Web shopping, various kinds of information retrievals and others by utilizing the server channels 1, 2, 3, 4, 5 for operation proxy, the user first pushes the power button 15, and starts the Internet terminal. Thus, the Internet terminal is automatically connected by the communication device 20 to the Internet 24 as a communication network so that the Internet terminal 14 attains an operable state. Next, the user pushes one channel button as a utilization object from the plural operation proxy channel buttons 23 of the Web site.

Thus, the Internet terminal is connected to one of the server channels 1, 2, 3, 4, 5 for operation proxy corresponding to the pertinent channel through the Internet 24, and the picture image of an operator 7 is displayed on the TV telephone screen 22. Web browser software is also started and contents of one of the Web site server channels 8, 9, 10, 11, 12 corresponding to the pertinent channel are displayed on the Web browser screen 21. Further, the same screen as the Web browser screen 21 on the user side is also displayed together with a picture image of the user in the server 6 for operation proxy on a side of the operator 7 by using the camera 17 with video capture and the microphone 18. Thus, bidirectional communication can be performed between the user and the operator 7. Accordingly, the user can have a conversation with the operator 7 by using a voice, and the Internet terminal attains a state in which operation proxy of the Internet terminal 14 on the user side can be executed.

Therefore, the user gives the commands of contents required to receive goods desired in purchase and various kinds of business services to the operator 7 by a normal conversation. The operator 7 executes the proxy of an operation of the Web browser screen 21 on the basis of these commands of the user while the operator 7 continues the conversation with the user by using the server 6 for operation proxy. The operator 7 executes the operation proxy until shopping or various kinds of business services as objects on the Web are completed.

For example, in an example of the purchase of goods, the operator 7 makes connection with the auxiliary memory devices 13, 13, - - - of goods information, service information, etc. of the Web site server channels 8, 9, 10, 11, 12 on the Internet 24 through the server 6 for operation proxy. The operator 7 then retrieves and peruses desirable goods of the user from a group of goods of various kinds, and gives an advance order or makes an application for purchase if there are desirable goods. Further, the operator 7 can retrieve the goods in accordance with specification, external appearance, item, performance, price, etc. of the desirable goods of the user, or can make inquires and can also request a detailed material such as a catalog, etc.

At this time, the user can visually confirm in real time that the Web browser screen 21 of the Internet terminal 14 utilized by the user is changed by the proxy operation of the operator 7. When the operation of the operator 7 is different from contents of the desirable goods and the various kinds of business services of the user, the user can immediately make a correction by transmitting the difference to the operator 7 by a conversation.

When the user is a skilled person and a keyboard and a mouse are attached to the Internet terminal 14 as an option, the user may also personally operate the Web browser screen 21 in addition to the operation of the operator 7. In this case, the user receives the provision of a commercial transaction or various kinds of business services by a mutual operation of the operator 7 and the user.

The present applicant proposed a mobile sales system in Japanese Patent application No. 2000-156763. In this mobile sales system, an Internet terminal unit is mounted to a vehicle for mobile sales, and a user retrieves, peruses and advance-orders goods not carried in the vehicle for mobile sales by making connection with a Web site server channel for a virtual shop through the Internet terminal unit in a traveling sales spot. Further, the advance-ordered goods are carried in the vehicle for mobile sales at the next traveling sales time or later, and are delivered to the user. When the present invention is applied to this mobile sales system, the Internet terminal 14 on a user side is arranged in advance within the vehicle for mobile sales, and a person in charge of a vehicle ride can also perform various kinds of proxy operations such as calling-out, etc. of the operator 7 from starting of this Internet terminal 14. Therefore, the user can achieve a predetermined object without coming in contact with the Internet terminal. Accordingly, no problem is caused even when it is difficult for the user to operate the Internet terminal 14, or the user is weak in this operation.

The advance-ordered or purchased goods are carried in the vehicle for mobile sales at the next traveling sales time or later, and are directly delivered or sold to the user. At this time, the user can directly check the goods advance-ordered or made in the application of purchase in one of the Web site server channels 8, 9, 10, 11, 12. Accordingly, when these goods are inferior goods and are different from intended goods, the user can cancel the purchase and can return the goods. The user pays the money to a person in charge of sales after the user directly confirms the goods. Hence, the user can carry out a purchase procedure after the user confirms the actual goods even in an Internet transaction. Accordingly, the user feels easy about the purchase, and the money can be reliably collected on a sales side.

The present invention is not limited to the commercial transaction business such as the purchase of goods, etc. carried out by the user, but can provide various kinds of onerous or gratuitous provided support businesses, information providing business, practical business proxy business, specialist introducing business, public service business, etc. to the user as other business services on the Web.

Records of the commercial transaction or the business service performed by proxy-operating the Web browser screen 21 of the user by the operator 7 are accumulated to a database of the servers 6, 6, - - - for operation proxy, and the user can confirm and recognize the records at any time in accordance with necessity. Otherwise, a provider of the Web site server channels 8, 9, 10, 11, 12 can utilize these data as information, and can also reflect these data in the construction of the Web site server channels.

The Internet terminal 14 on the user side includes a terminal unit arranged within a convenience store, a specialty store or the above vehicle for mobile sales, and an electronic device for home able to connected to the Internet such as a Web TV, etc. in addition to a personal computer mounting the Web browser thereto, a game machine, a portable terminal, a portable phone, and an Internet terminal unit.

As explained above, the present invention is mainly characterized in that no Web browser of the Internet terminal 14 is personally operated by the user, but the user and the operator 7 in a remote place have a conversation by using a communication means such as the TV telephone screen 22, etc. utilizing the Internet 24, and the user transmits a desirable condition to the operator 7, and the user receives the provision of shopping or various kinds of business services on the Web by proxy-operating the Web browser screen 21 of the user by the operator 7. Accordingly, a commercial transaction means and a business service receiving means able to be easily adopted can be also provided to the user unable to operate a device such as a personal computer, etc.

As explained above in detail, in accordance with the present invention, the user can do shopping, or can receive various kinds of onerous or gratuitous provided business services on the Web without personally operating the Web browser by the user. Accordingly, the user can utilize the Internet terminal without any problem even when the user is weak in the operation of the personal computer. Therefore, the Internet terminal in the present invention can cope with an aging society in the future, and is suitable for all people, and can greatly contribute to an increase in utilization of the Internet.

It is not necessary for the user to operate the Internet terminal unit. Therefore, a keyboard and a mouse are not required, and it is sufficient to operate only the Web browser in a main body of the terminal unit. Accordingly, it is not necessary to arrange a CPU operated at high speed, a memory of a large capacity, etc., and the Internet terminal can be made compact and light in weight and manufacturing cost can be reduced by using a note type personal computer.

In the example of a commercial transaction, the operator of a server channel for operation proxy gets access to the Web site server channel instead of the user, and retrieves goods in agreement with a desirable purchase condition of the user. Accordingly, everybody can purchase goods without any problem. When the terminal unit of a vehicle for mobile sales is used, the vehicle for mobile sales goes round a resident area of the user at any time so that purchased goods can be periodically carried in accordance with a delivery route. Therefore, it is possible to reduce additional cost taken in the delivery as in the conventional Internet mail order sales. In particular, the user can buy and sell goods, and can receive various kinds of business services on the Web of the Internet without actually going to a department store, a supermarket and a specialty store so that convenience in life is improved.

Further, records of the commercial transaction or the business service performed by proxy-operating the Web browser of the user on the Web by the operator are accumulated to a database by the server for operation proxy. The user can confirm a history of the commercial transaction, etc. of the user in accordance with necessity, and a business service provider can obtain sales management information from the accumulated information and can reflect the sales management information in the business service so that sales in the commercial transaction are improved.

Further, an Internet terminal unit arranged within a convenience store, a specialty store or a vehicle for mobile sales, and an electronic device for home able to be connected to the Internet such as a Web TV, etc. can be utilized as an electronic device on the user side in addition to a personal computer mounting the Web browser thereto, a game machine, a portable terminal, a portable phone, and an Internet terminal unit. Therefore, goods can be sold and various kinds of business services can be performed at any time and place, and the objects of treated goods and business services on the Web can be enlarged.

What is claimed is:

1. An Internet terminal having an operation proxy channel button of a Web site, characterized in that the Internet terminal mounting a Web browser thereto on a user side is connected to a server channel for operation proxy through the Internet, and a single or plural operation proxy channel buttons of the Web site and communication means with an operator of the server channel for operation proxy are arranged in the Internet terminal, and connection with a Web site server channel and other operations are performed by proxy-operating the Web browser of the Internet terminal on the user side by the operator through the Internet on the basis of commands of the user through the communication means.

2. An Internet terminal having an operation proxy channel button of a Web site, characterized in that the Internet terminal on a user side is connected to a server channel for operation proxy through the Internet, and a single or plural operation proxy channel buttons of the Web site and communication means with an operator of the server channel for operation proxy are arranged in the Internet terminal, and various kinds of connections with a Web site server channel and other operations are performed by proxy-operating a Web browser of the Internet terminal on the user side by the operator through the Internet on the basis of commands of the user through the communication means so that the user receives the provision of a commercial transaction or various kinds of business services on the Web site server.

3. The Internet terminal having the operation proxy channel button of the Web site as defined in claim 1 or 2, wherein the Internet terminal is connected to one of the single or plural server channels for operation proxy by selecting one of said single or plural operation proxy channel buttons of the Web site, and contents of one of the Web site server channels corresponding to the pertinent server channel for operation proxy are displayed on a Web browser screen of the Internet terminal.

4. The Internet terminal having the operation proxy channel button of the Web site as defined in claim 1, 2 or 3, wherein a virtual operator is made as the operator of the server channel for operation proxy by agent software of a computer, and proxy-operates the Web browser of the Internet terminal on the user side on the basis of the commands of the user.

5. The Internet terminal having the operation proxy channel button of the Web site as defined in claim 1, 2, 3 or 4, wherein the operation proxy channel button of the Web site is selected from a hardware button of a dial and others assembled into the Internet terminal, or a software button displayed on a screen able to perform an input operation such as a touch panel, etc., a button assembled into a remote controller able to be connected to the Internet terminal by an infrared or wireless interface, and other remote operation buttons.

6. The Internet terminal having the operation proxy channel button of the Web site as defined in claim 1, 2, 3, 4 or 5, wherein means of a chat through the Internet, an Internet telephone, an Internet TV telephone, etc. are used as the communication means of the user and the operator.

7. The Internet terminal having the operation proxy channel button of the Web site as defined in claim 1, 2, 3, 4, 5 or 6, wherein the operator performs a proxy-operation required for retrieval, an application, etc. for receiving a provided business by making connection with a Web site server channel for various kinds of business services such as various kinds of support businesses, information providing business, public service business, etc. as the Web site server channel.

8. The Internet terminal having the operation proxy channel button of the Web site as defined in claim 1, 2, 3, 4, 5, 6 or 7, wherein the records of operations of the Internet terminal performed by the operator on the user side are accumulated to a database by the server channel for operation proxy, and the user can confirm the records, or a provider of the Web site server channel can utilize the records as information.

9. The Internet terminal having the operation proxy channel button of the Web site as defined in claim 1, 2, 3, 4, 5, 6, 7 or 8, wherein a personal computer mounting the Web browser thereto, a game machine, a portable terminal, a portable phone, a terminal unit arranged within a convenience store, a specialty store or a vehicle for mobile sales, and an electronic device for home able to be connected to the Internet such as a Web TV, etc. are used as the Internet terminal on the user side.
